(19) United States
(12) Patent Application Publication
(10) Pub. No.: US 2014/0184317 A1
(43) Pub. Date: Jul. 3, 2014

(54) ELECTRONIC DEVICE TO CONTROL VOLTAGE FLUCTUATIONS

(71) Applicants: Alexander B. UAN-ZO-LI, Hillsboro, OR (US); Christopher B. Wilkerson, Portland, OR (US); Jorge P. Rodriguez, Portland, OR (US); Jeremy J. Shrall, Portland, OR (US)

(72) Inventors: Alexander B. UAN-ZO-LI, Hillsboro, OR (US); Christopher B. Wilkerson, Portland, OR (US); Jorge P. Rodriguez, Portland, OR (US); Jeremy J. Shrall, Portland, OR (US)

(21) Appl. No.: 13/728,677

(22) Filed: Dec. 27, 2012

(51) Int. Cl. G05F 3/16

(52) U.S. Cl. CPC G05F 3/16
USPC 327/541

(57) ABSTRACT

An electronic device may include a power delivery system to provide a voltage, and an integrated circuit having a processor to receive the voltage. When the received voltage exceeds a prescribed value, the integrated circuit to perform an act to consume current from the power delivery system.

### BACKGROUND

1. Field

Embodiments may relate to controlling voltage fluctuations to a processor.

2. Background

Manufacturers of electronic devices are attempting to make smaller and smaller electronic devices. Additionally, areas around processors have become more crowded.

### BRIEF DESCRIPTION OF THE DRAWINGS

Arrangements and embodiments may be described in detail with reference to the following drawings in which like reference numerals refer to like elements and wherein:

FIG. 1 is a diagram of a processor and a power delivery system according to an example arrangement;

FIG. 2 shows graphs of a transient response of a power delivery system according to an example arrangement;

FIG. 3 is a diagram of a processor and a power delivery system according to an example embodiment;

FIG. 4 is a diagram of an integrated circuit, a comparator and a power delivery system according to an example embodiment; and

FIG. 5 shows graphs of a transient response of a power delivery system according to an example embodiment.

### DETAILED DESCRIPTION

In the following detailed description, like numerals and characters may be used to designate identical, corresponding and/or similar components in differing figure drawings. Further, in the detailed description to follow, example sizes/models/values/ranges may be given although embodiments are not limited to the same. Where specific details are set forth in order to describe example arrangements and embodiments, it should be apparent to one skilled in the art that arrangements and embodiments may be practiced without these specific details.

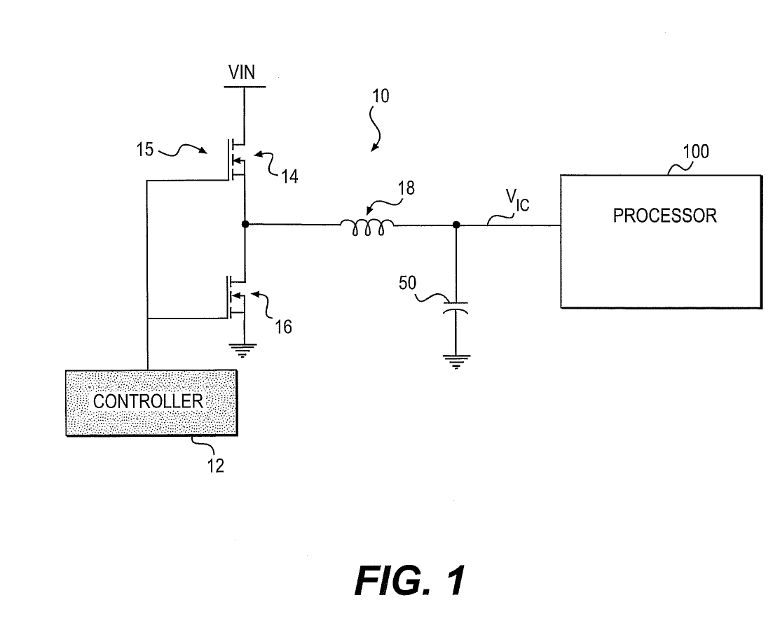

FIG. 1 is a diagram of a processor and a power delivery system according to an example arrangement. Other arrangements may also be provided.

More specifically, FIG. 1 shows a processor 100 that receives power from a power delivery system 10. The processor 100 may be a central processing unit (CPU) or other type of processor.

The power delivery system 10 may include a voltage supply (or power supply) and a voltage regulator (VR). The voltage regulator may include a controller 12, a buck converter 15 (or converter), an inductor 18 and a decoupling capacitor 50 (or capacitor). The controller 12 may be considered as being part of the voltage regulator, or the controller 12 may be considered as a separate component from the voltage regulator.

The buck converter 15 may be formed of a first switching transistor 14 and a second switching transistor 16. The first and second switching transistors 14, 16 may each be a field effect transistor (FET).

The first and second switching transistors 14 and 16 may be controlled by the controller 12 to provide an input voltage Vic. The controller 12 may apply signals to gates of the first and second switching transistors 14, 16 to control the transistors 14, 16 and thereby provide an output power from the voltage regulator (or input power to the processor 100).

The voltage regulator (including the converter 15 and the inductor 18) may provide the input voltage Vic to the processor 100. The voltage regulator may provide a stable input voltage, such as the input voltage Vic.

The processor 100 may operate at different speeds and/or operate in different modes. The different speeds, operations and/or modes of the processor 100 may occur while receiving the stable input voltage. As one example, the processor 100 may change its speed when an instruction or calculation is executed by the processor 100. When the processor 100 lowers its frequency, then the amount of current drawn from the voltage regulator by the processor 100 may decrease, and accordingly the input voltage Vic to the processor 100 may increase momentarily due to the inherent transient response of the voltage regulator. This may be considered a load step down (or load step) since the processor 100 (i.e., a load) has a decreased amount of needed power (and thus a decreased input current). However, due to the increased input voltage to a platform, package, integrated circuit or processor, a voltage overshoot may occur, such as with regard to electronic components.

Manufacturers of electronic devices are attempting to make smaller and smaller electronic devices. Areas within a package (integrated circuit) around respective processors have become more crowded. Thus, a size of the decoupling capacitor 50 may affect an overall size of the electronic device.

The size of the decoupling capacitor 50 may affect overall system cost and size. The size of the decoupling capacitor 50 may be based at least in part on an amount of voltage overshoot that may be provided during a load step down. The size of the decoupling capacitor 50 may be specifically designed in order to protect other electronic circuitry that may be very sensitive to the applied voltage (or input voltage). That is, if the input voltage Vic exceeds safe operating margins, then the electronic circuitry may be damaged. As one example, an amount of decoupling (based on the decoupling capacitor 50) may be proportional to a square of the load step down.

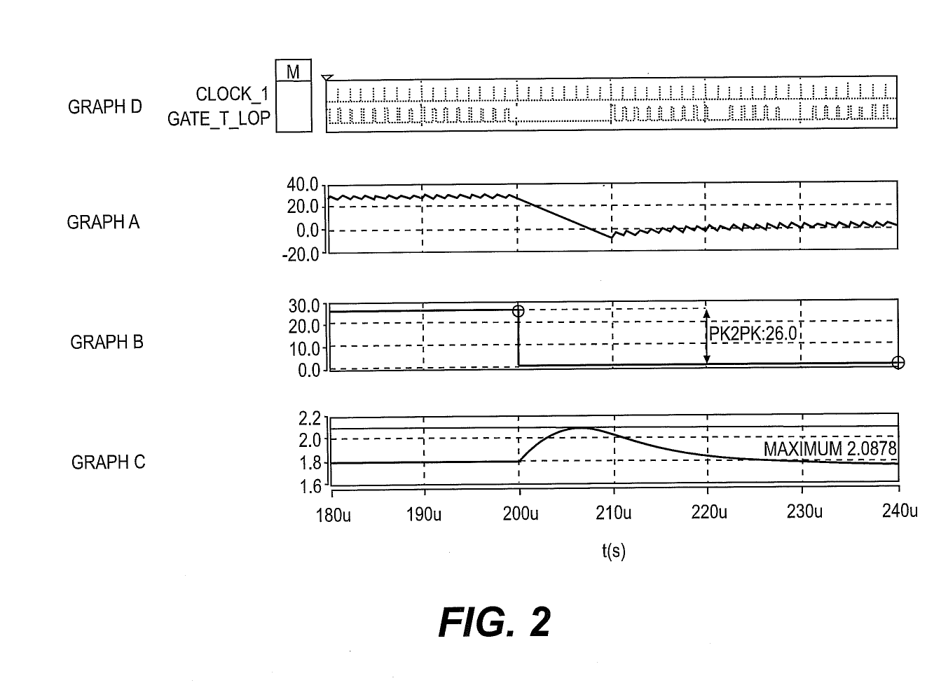

FIG. 2 shows graphs of a transient response of the power delivery system 10 (FIG. 1) according to an example arrangement. Other arrangements may also be provided.

Graphs A-D show simulated waveforms that may occur when the processor 100 experiences a load step down without any active overshoot suppression.

Graph A shows a simulated waveform of the current flowing through the inductor 18. Graph B shows the simulated waveform of the current being used by the processor 100. Graph C shows the simulated waveform of the output voltage of the voltage regulator (i.e., the input voltage Vic of the processor). Graph D shows simulated logic signals of the voltage regulator clock and the gate signal driving the switch 14 in FIG. 1.

As may be seen in the simulation for a voltage regulator with realistic parameters of platform regulators, the output voltage of the voltage regulator experiences an overshoot during the load step down. This may occur because of non-linear effects introduced due to inherent limitations of the voltage regulator (i.e., the duty cycle can not be negative).

In order to avoid or lessen problems based on voltage spikes or power supply fluctuations, a package architecture (that includes a processor) may include a mechanism to address the power supply fluctuations, such as a voltage overshoot.

In an example arrangement, an ICC protector may be provided for voltage supply droops. The ICC protector may ensure that a maximum current draw is not exceeded by determining (or checking) to ensure that certain instructions are not being executed in a particular sequence.

Embodiments may provide a mechanism to respond to a power supply droop or avoid a power supply droop. The mechanism may mitigate power supply spikes (or voltage supply spikes).

As one example, a processor core may execute (or run) a power-virus to allow the processor 100 to draw additional current until the voltage regulator transient is finished. This may reduce the duration of the power supply spikes (or the voltage supply spikes). The power-virus may be a sequence of instructions having a very high activity factor. The power-virus may run (or be executed) when a sensor (or sensing device) detects an input voltage that exceeds a particular threshold. The sensing device may be a comparator, for example. The processor core may directly inject a micro-code flow (containing the power-virus) into a pipeline. The power-virus may run concurrently with threads running in the pipeline, and may contain approximately 100-200 uops at a time, for example, This may help avoid interfering with execution of the program.

As another example, embodiments may use a power sink to limit voltage excursions. The power sink may be provided in the processor 100 (or within a package that includes the processor 100). The power sink may limit voltage excursions in a power consumption mode of the processor 100 (or the package or the integrated circuit).

The power consumption mode may be provided when the input voltage Vic (from the voltage regulator) is at or above a prescribed voltage. Thus, the power consumption mode may have negligible effects on average processor power consumption.

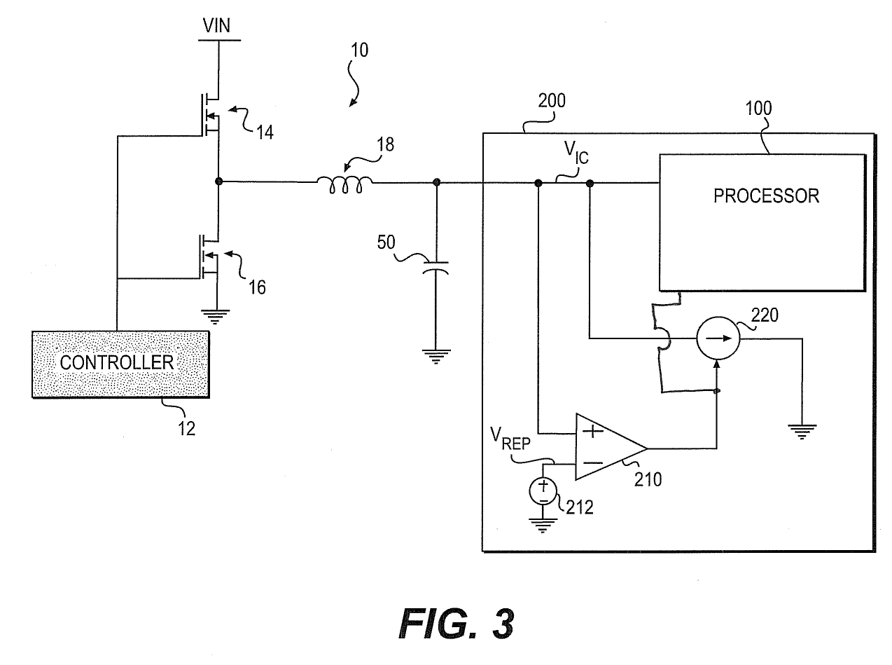

FIG. 3 is a diagram of a package and a power delivery system according to an example embodiment. Other embodiments and configurations may also be provided.

More specifically, FIG. 3 shows the power delivery system 10 that delivers power to an integrated circuit (IC) 200 (or package). The IC 200 may be a processor (such as a CPU), a graphics IC or any other kind of computing device. The power delivery system 10 may provide the input voltage Vic based on the voltage regulator of the power delivery system 10.

The IC 200 may include the processor 100, as well as a comparator 210, a voltage source 212, and a current sink 220, for example. Other electrical components may also be provided within the IC 200.

FIG. 3 shows the comparator 210 being within the IC 200. The comparator 210 may be considered as being within the processor 100. The comparator 210 may include a positive (+) input terminal and a negative (−) input terminal. Other sensing devices may be provided in place of the comparator 210.

FIG. 3 shows that the IC 200 includes voltage source 212 to provide a reference voltage Vref (or prescribed voltage) to the negative input (−) of the comparator 210. The input voltage Vic (to the IC 200) may be provided to the positive input (+) of the comparator 210.

The comparator 210 (or other sensing device) may determine, based on inputs to the comparator 210, when the input voltage Vic is at (or above) the prescribed value (i.e., the reference voltage Vref). The comparator 210 may provide an output signal based on this determination. When the comparator 210 determines that the input voltage Vic is at (or above) the prescribed value (Vref), then the output signal may turn on (or off) the current sink 220 provided within the IC 200 (or the processor 100). The current sink 220 may draw current (from the voltage regulator) to ground when the current sink 220 is turned on. This may help limit the overshoot voltage of the input of the processor 100 and/or causing electrical malfunction of other electrical components of the IC 200. The above description is an action (or operation) to consume current provided from the power delivery system 10. The above description also describes that the current sink 220 to operate in response to a determination that the input voltage Vic is above a prescribed value.

In another embodiment, when the comparator 210 determines that the input voltage Vic is at (or above) the prescribed value Vref, then the output signal may cause the processor 100 to increase its power consumption. For example, the output signal (from the comparator 210) may cause the processor 100 to execute dummy instructions, which may result in more current being drawn from the voltage regulator (and the input voltage Vic may decrease). This may help limit the overshoot voltage of the input of the IC 200 (or the processor 100) and/or causing electrical malfunction of other electrical components of the IC 200. The above description is an action (or operation) to consume current provided from the power delivery system 109. The above description also describes that the processor 100 to operate in response to a determination that the input voltage Vic is above a prescribed value.

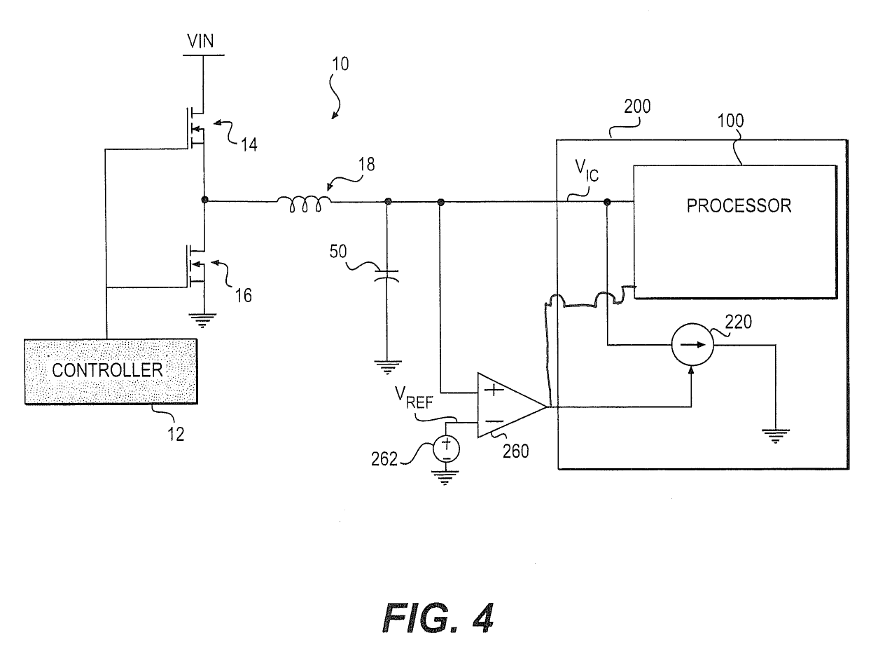

FIG. 4 is a diagram of an integrated circuit (or package), a comparator and a power delivery system according to an example embodiment. Other embodiments and configurations may also be provided.

More specifically, FIG. 4 shows the power delivery system 10 that delivers power to the IC 200. In FIG. 4, a comparator 260 (or other sensing device) and a voltage source 262 may be provided external to the IC 200. The comparator 260 may include a positive (+) input terminal and a negative (−) input terminal. Other sensing devices may be provided in place of the comparator 260.

FIG. 4 also shows that the voltage source 262 may provide the reference voltage Vref to the negative input (−) of the comparator 260. The input voltage Vic may be provided to the positive input (+) of the comparator 260.

The comparator 260 (or other sensing device) may determine, based on inputs to the comparator 260, when the input voltage Vic is at (or above) the prescribed value (i.e., the reference voltage Vref). The comparator 260 may provide an output signal based on this determination. When the comparator 260 determines that the input voltage Vic is at (or above) the prescribed value Vref, then the output signal may turn on (or off) the current sink 220 provided within the IC 200 (or the processor 100). The current sink 220 may draw current (from the voltage regulator) to ground when the current sink 220 is turned on. This may help avoid over-voltage on the processor 100 and/or causing electrical malfunction of other electrical components of the IC 200.

The comparator 260 as well as the voltage source 262 may be part of the controller 12 in at least one embodiment. Other embodiments may use more complex techniques inside the controller 12 to signal to the processor 100 to temporarily turn on the current sink (or a dummy code) in order to lower the voltage Vic.

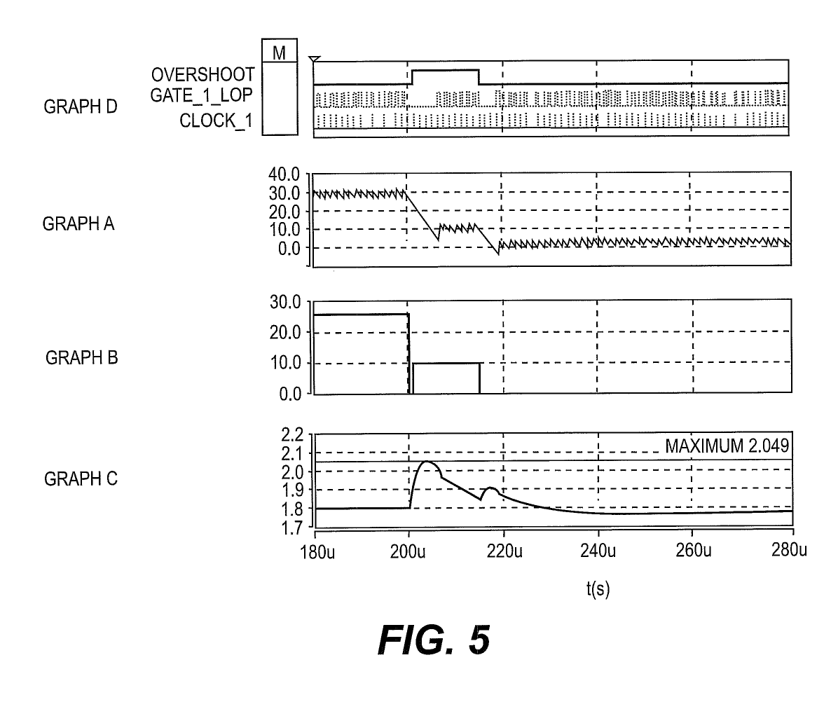

FIG. 5 shows graphs of a transient response of the power delivery system 10 according to an example embodiment. Other graphs and embodiments may also be provided.

Graph A shows a simulated waveform of the current flowing through the inductor 18. Graph B shows the simulated waveform of the current being used by the processor 100. Graph C shows the simulated waveform of the output voltage of the voltage regulator (i.e., the input voltage Vic of the processor). The signals of Graph D (from top to bottom) show the output of the amplifier 260, the gate signal to the transistor 14 and the voltage regulator clock signal.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. An electronic device comprising:
a power delivery system to provide a voltage; and
an integrated circuit having a processor on the integrated circuit, the integrated circuit to receive the voltage, and when the received voltage exceeds a threshold value, a component of the integrated circuit to perform an action to consume current from the power delivery system.

2. The electronic device of claim 1, wherein the action to limit an overshoot voltage at an input to the processor.

3. The electronic device of claim 1, wherein the component of the integrated circuit includes a current sink on the integrated circuit having the processor, the current sink to draw current from the power delivery system when the voltage received from the power delivery system exceeds the threshold value.

4. The electronic device of claim 3, further comprising a comparator to provide a signal indicating that the voltage received from the power delivery system exceeds the threshold value.

5. The electronic device of claim 4, wherein the signal from the comparator is to be provided to the current sink when the voltage received from power delivery system exceeds the threshold value.

6. The electronic device of claim 5, wherein the comparator is external to the integrated circuit.

7. The electronic device of claim 5, wherein the comparator is part of the integrated circuit.

8. The electronic device of claim 1, further comprising a comparator to provide a signal to the processor on the integrated circuit when the voltage received from the power delivery system exceeds the threshold value.

9. The electronic device of claim 8, wherein the processor to execute an instruction to consume the current in response to the signal provided from the comparator to the processor.

10. The electronic device of claim 9, wherein the instruction is a dummy instruction to result in the current being drawn by the processor.

11. The electronic device of claim 8, wherein the comparator is external to the integrated circuit.

12. The electronic device of claim 8, wherein the comparator is part of the integrated circuit.

13. The electronic device of claim 1, wherein the power delivery system includes a voltage regulator.

14. An integrated circuit device comprising:
an integrated circuit having a processor to receive a voltage, the processor provided at the integrated circuit, and when the received voltage exceeds a threshold value, a component of the integrated circuit to perform an action to consume current.

15. The integrated circuit device of claim 14, wherein the action to limit an overshoot voltage at an input to the processor.

16. The integrated circuit device of claim 14, wherein the component of the integrated circuit includes a current sink at the integrated circuit having the processor, the current sink to draw current when the received voltage exceeds the threshold value.

17. The integrated circuit device of claim 16, further comprising a comparator to determine when the received voltage exceeds the threshold value.

18. The integrated circuit device of claim 17, wherein the comparator to provide a signal to the current sink when the received voltage is determined to exceed the threshold value.

19. The integrated circuit device of claim 18, wherein the comparator is external to the integrated circuit.

20. The integrated circuit device of claim 18, wherein the comparator is part of the integrated circuit.

21. The integrated circuit device of claim 14, further comprising a comparator to provide a signal to the processor at the integrated circuit when the received voltage exceeds the threshold value.

22. The integrated circuit device of claim 21, wherein the processor to execute an instruction to consume the current in response to the signal provided from the comparator to the processor.

23. The integrated circuit device of claim 22, wherein the instruction is a dummy instruction to result in the current being drawn by the processor.

24. The integrated circuit device of claim 21, wherein the comparator is external to the integrated circuit.

25. The integrated circuit device of claim 21, wherein the comparator is part of the integrated circuit.

26. An electronic device comprising:
a power delivery system to provide a voltage;
an integrated circuit having a processor on the integrated circuit, the integrated circuit to receive the voltage; and
a comparator to provide a signal to the processor on the integrated circuit when the voltage received from the power delivery system exceeds a threshold value, and the processor to perform an action to consume current from the power delivery system in response to the received signal.

27. The electronic device of claim 26, wherein the processor to execute an instruction to consume the current in response to the signal provided to the processor.
